(19) United States
(12) Patent Application Publication
(10) Pub. No.: US 2018/0152038 A1
(43) Pub. Date: May 31, 2018

(54) DUAL ZONE CONTROLLER

(71) Applicant: Charles Gayle, Charlotte, NC (US)

(72) Inventor: Charles Gayle, Charlotte, NC (US)

(21) Appl. No.: 15/717,609

(22) Filed: Sep. 27, 2017

Related U.S. Application Data
(60) Provisional application No. 62/497,597, filed on Nov. 25, 2016.

(51) Int. Cl. H02J 7/00

(52) U.S. Cl. CPC H02J 7/0068; H02J 7/0077

(57) ABSTRACT

A controller for controlling power flows may include a first charging circuit to charge and discharge a first battery responsive to the controller; and a second charging circuit to charge and discharge a second battery responsive to the controller. The first charging circuit and the second charging circuit alternates between charging and discharging. The first charging circuit charges while the second charging circuit discharges and the first charging circuit discharges while the second charging circuit charges.

### FIELD OF THE INVENTION

The present invention relates to a Dual Zone controller device and more particularly to a device that will control Multiple Batteries with Optional Ports.

### SUMMARY OF THE INVENTION

The controller of the present invention having the ability to change its configuration depending on the number of batteries connected to the ports. This configuration flexibility allows the controller to output multiple voltages while maintaining the ability to accept a low charging voltage.

This controller device also has the ability to switch from a Master Zone to a Secondary Zone at a high speed, to avoid any disruption on the output grid. This switching feature may be activated by the voltage in the zone that is supplying voltage to the output grid.

The present invention with the ability to monitor a battery pack, supply voltage, charges a set of Batteries and changes its configuration to obtain maximum performance. This Controller may have two or more ZONES operating independently of each of the zones, allowing the zones to perform multiple operations without any conflict between the zones. However, even though the zones are independent, during critical situation both zones may communicate with each other through the controller to resolve the problem.

### BRIEF DESCRIPTION OF THE DRAWINGS

FIG. 1 illustrates a circuit diagram of the dual zone controller of the present invention;

FIG. 1a illustrates a portion of the circuit diagram of the dual zone controller;

FIG. 2 illustrates a circuit diagram of the dual zone controller of the present invention;

FIG. 2a illustrates a portion of the circuit diagram of the dual zone controller of the present invention;

FIG. 3 illustrates a circuit diagram of the dual zone controller of the present invention;

FIG. 3a illustrates a portion of the circuit diagram of the dual zone controller;

FIG. 4 illustrates a circuit diagram of the dual zone controller of the present invention;

FIG. 5 illustrates a circuit diagram of the dual zone controller of the present invention;

FIG. 6 illustrates a circuit diagram of the dual zone controller of the present invention;

FIG. 7 illustrates a circuit diagram of the dual zone controller of the present invention;

FIG. 8 illustrates a circuit diagram of the dual zone controller of the present invention;

FIG. 9 illustrates a circuit diagram of the dual zone controller of the present invention;

FIG. 10 illustrates a circuit diagram of the dual zone controller of the present invention;

FIG. 11 illustrates a circuit diagram of the dual zone controller of the present invention

### DETAILED DESCRIPTION

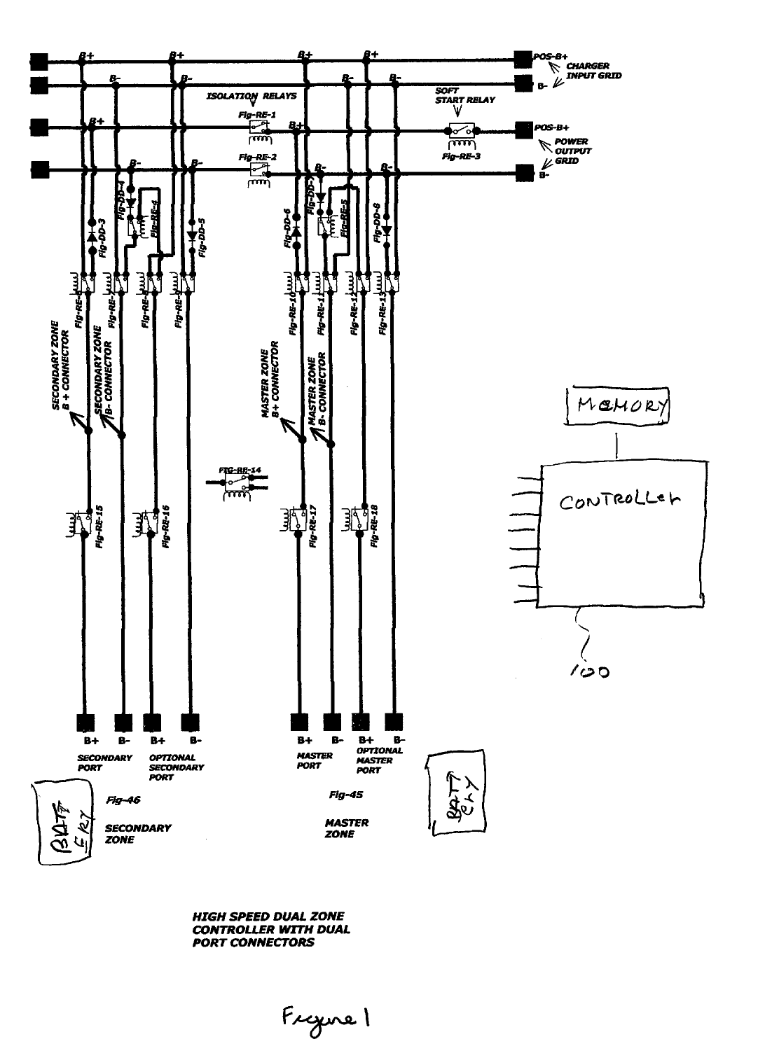

For example, page-1, FIG. 1 labeled MASTER ZONE Fig-45 is used to supply output voltage through the master port blocking and supplying diodes Fig-DD-6 Fig DD-7 to the output grid along with the switchover relays Fig-10 Fig-11 and Fig-RR-5, however, if the optional ports is enabled (in operation) than relay fig-RR-5 is deactivated causing the controller to disregard fig-DD-7 and start supplying its negative voltage through the fig-DD-8 along with fig-RR-12 and fig-RR-13. These components should be rated according to manufacturer desire amps on the output grid. Zone two labeled SECONDARY ZONE Fig-46 would remain in the charge mode setting utilizing relays fig-RR-7 fig-RR-8 fig-RR-9 until it receives a switchover command from the MASTER ZONE Fig-45 through the controller 100. This configuration allows the SECONDARY ZONE Fig-46 to receive a charging voltage to replenish the batteries in that zone.

When the MASTER ZONE Fig-45 depletes its voltage for example when the voltage drops below a predetermined level, the charging zone which is the SECONDARY ZONE Fig-46 would receive an activating command from the controller 100. This command would allow the SECONDARY ZONE Fig-46 to change its configuration from charging to supplying voltage to the grid. This voltage is applied to the grid output bodies held in isolation by the isolation relays Fig-RR-1 and Fig-RR-2 until the MASTER ZONE Fig-45 is disconnected from the power grid by the controller 100.

The configuration of the MASTER ZONE Fig-45 would be changed by the controller 100 to receive the charge voltage. After the secondary zone fig-46 is discharged to a predetermined level, the configuration is again changed by the controller 100 so that the secondary zone fig-46 is charging and the master zone fig-45 is discharging. This feature of Supplying, Charging, and Changing its configuration allows the Controller 100 to continuously maintain at least one of one of the battery pack from either the master zone or the secondary zone to be fully charge and to be discharged on the next cycle of operation.

Changing its configuration in each zone allows the controller 100 to output a variety of voltages. This is achieved by utilizing the OPTIONAL PORTS in each zone—when a battery is connected to these OPTIONAL PORTS the controller 100 would sense the batteries and change its configuration to output the appropriate voltage. To achieve this change the controller 100 activates FIG. 1 relays Fig-RE-4 & Fig-RE-5. These relays sense the voltage from the respective optional master port or optional secondary port and are activated by the controller 100 causing the output to increase to the appropriate voltages according to the number of batteries connected to that zone.

This configuration would remain in effect until the Batteries connected to the Optional Ports are disconnected, causing the controller 100 to return to the original configuration.

To achieve all of these operations, the Controller 100 employs several components. These components are illustrated on several pages of drawing. (Page # One/FIG. 1) shows the (ISOLATION RELAYS Fig-RE-1 & RE-2 to isolate either the master port or the secondary port.) (SWITCH OVER RELAY Fig-RE-4 RE⋅5, RE-6, RE-7, RE-8, RE-9, RE-10, RE-11, RE-12, RE-13, and RE-14 to select a specific grid from either the charger input grid for the power output grid in accordance with control signals from the controller 100, VOLTAGE BLOCKING DIODES Fig-DD-3, Fig-DD-4, Fig-DD-5, Fig-DD-6, Fig-DD-7, and Fig-DD-8 to allow the flow of voltage in only one direction. (DISABLE AND ENABLE RELAYS (which are the on/off relays) Fig-RE-15, Fig-RE-16, Fig-RE-17, and Fig-RE-18 to disable and enable specific ports for example the master port and/or the secondary port in accordance with control signals from the controller 100.)

Page #1/FIG. 1 also indicates where all Master Zone Positive and Negative and Secondary Zone Positive and Negative connections are located. It is important to note that all connections should be made at these locations. This is due to the flexibility of the Optional Ports would cause the controller 100 to lose voltage when the Optional batteries are disconnected.

Finally, on page #1 is an output (DELAY RELAY) Fig-RE-3. The supporting circuitry is not shown on this page/figure. The delay relay Fig-RE-3 delays the application of the output voltage to ensure the controller 100 is powered up. Without this delay relay Fig-RE-3, there could be a Voltage bounce causing the zones to switch premature. This may happen when large amount of amperage are being drawn from the supplying zone.

To fully understand the circuitry of FIG. 1, we need to consult (Page#2) with its additional connections, circuitry, and supporting components. Condensers Fig-C1, Fig-C2, Fig-C3 and Fig-C4 Protection diodes Fig-1 and Fig-16 which are connected across the output grid are important to the stability of the controller 100. The Condensers Fig-C1, Fig-C2, Fig-C3 and Fig-C4 stabilize the output voltage while switching from Zone to Zone. The diodes Fig-1 & Fig-16 across the output grid are used for protecting the output voltage, additional diodes & condensers could be added. This feature pertaining to the diode protection is known in the Industry.

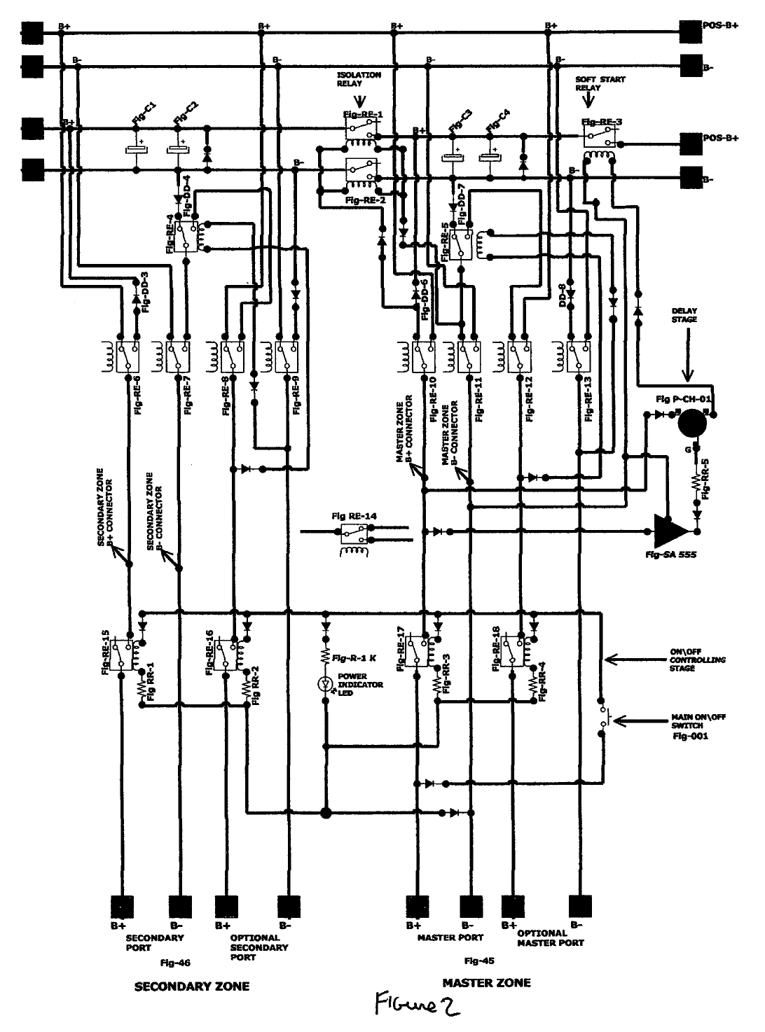

Illustrated on page #2/FIG. 2 are the connecting Optional Port Switchover O.P.S. Relays Fig-RE-4 & Fig-RE-5 which are controlled by the controller 100. These relays Fig-RE-4 & Fig-RE-5 are connected through the diodes Fig-DL-2 & Fig-DL-1 For the Master Zone O.P.S Relays which are controlled by the controller 100 and Fig-DL-3 & Fig-DL-4 Is used for the Secondary Zone O.P.S. Relays. Illustrated also Is a Sample Delay circuitry with its supporting components: a timer chip Fig-SA555, resistor Fig-RR-5, High speed Transistor Fig-P-CH-01, and diodes. The timer chip Fig-SA555 enables the Transistor Fig-P-CH-01 to power the Delay Relay Fig-RE-3. Connection for the ISOLATION RELAYS Fig-RE-1 & Fig-RE-2 are shown, Fig-DD-030 & Fig-DD-040 are the diodes which power the relays. Please note there connection to the controller 100 for proper operation.

The Main On\Off Controlling Relays Fig-RE-15, RE-16, RE17, & RE-18 to turn off and on the main zone and the secondary zone. Switch Fig-001 may be used to apply voltage to these relays Fig-RE-15, RE-16, RE17, & RE-18. The Resistors Fig RR-1, RR-2, RR-3, & RR-4, and diodes Fig-21, Fig-22, Fig-11, and Fig-12 may regulate the Voltage and Amperage on the coil of the relays Fig-RE-15, RE-16, RE17, & RE-18. One terminal of Fig-14 provides the Positive voltage to Flg-001 switch to power the relays, another terminal of Fig-14 supplies the Negative.

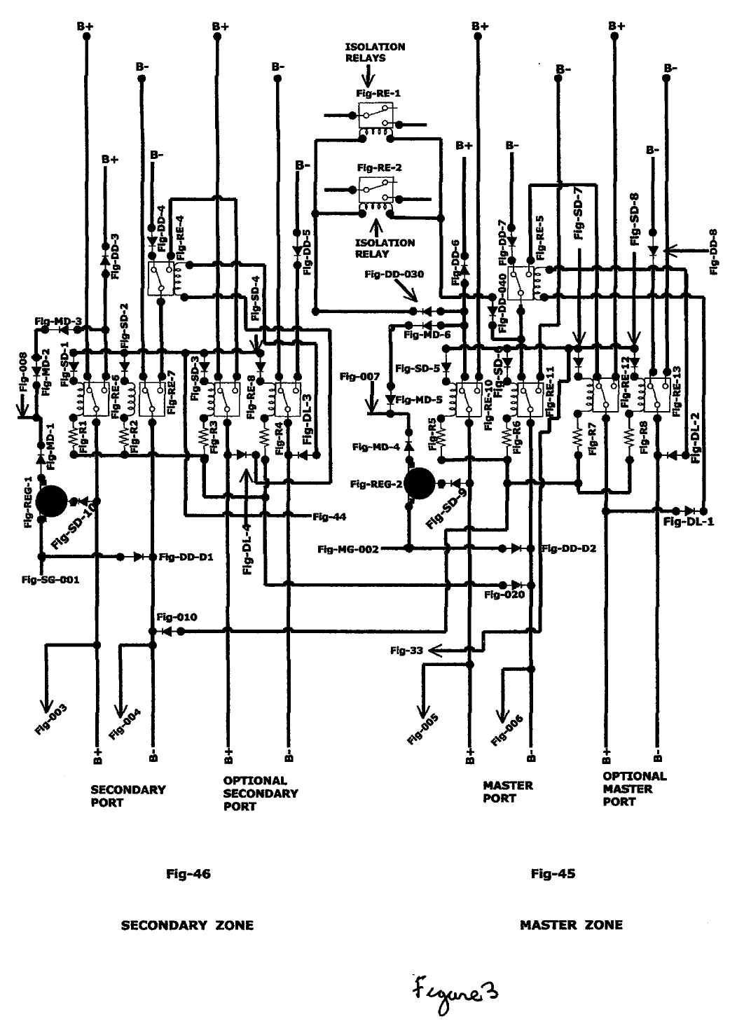

Page #3/FIG. 3 showing components and grids, shows diodes Fig-DD-3, DD-4, DD-5, DD-6, DD-7, & DD-8. These Diodes Fig-DD-3, DD-4, DD-5, DD-6, DD-7, & DD-8 may supply voltage to the output grid and block any feedback voltage from the grid. Diodes Fig-DD-3 & Fig-DD-6 are used to supply the Positive voltage to the grid while diodes Fig-DD-4, Fig-DD-5, Fig-DD-7, & Fig-DD-8 supplies the Negative.

The Switchover Relays Fig-RE-6, RE-7, RE-8, & RE-9 which are controlled by the controller 100 may be used for the Secondary Zone while Switchover Relays Fig-RE-10, RE-11, RE-12, & RE-13 may be used for the Master Zone. Diodes Fig-SD-1, SD-2, SD-3, SD-4 and Resistors Fig-R1, R2, R3, & R4 are the Secondary Zone voltage supply circuit elements while diodes Fig-SD-5, SD-6, SD-7, SD-8 and Resister Fig-R5, R6, R7, & R8 are Master Zone voltage supply circuit elements.

As shown in Page #3/FIG. 3, diode Fig-010 provides the Negative voltage for the Master Zone Switchover Relays while diode Fig-020 provides the Negative voltage for the Secondary Zone Switchover Relays.

Monitoring Diodes Fig-MD-2 & MD-3 are used for the Secondary Zone while diodes Fig-MD-5 & MD-6 are diodes for the Master Zone. The stabilization Regulator Transistors Fig-REG-1 and Fig-REG-2 coupled with the supplied diodes Fig-MD-1 & Fig-MD-4 these components performed a delicate operation. The Diodes Fig-MD-2 & MD-3, Fig-MD-5 & MD-6 provide the voltage to be monitored by the controller 100, however the regulator regulates the voltage to ensure that a low voltage is present with the monitoring voltage. When the Monitoring Voltage is removed due to Switchover Relay settings, the low Voltage from the regulator continued to power the Monitoring chip ensuring the stage stays low.

The connection point for the Monitoring stage is Fig-008 for the Secondary Zone while Fig-007 provides the connection point for the Master Zone. Diodes Fig-SD-9 & Fig-SD-10 may power the Regulators, however diodes Fig-DD-D1 for the secondary zone and diodes Fig-DD-D2 for the Master Zone are two amp diodes are better rated. Ground (B−) connection Fig-SG-001 may be for all Secondary Zone while Ground (B−) connections point FIG-MG-002 may be for the Master Zone.

Fig-44 indicates where the Secondary Zone connects to the Master Zone to receive its controlling voltage from the controller 100; Fig-33 indicates where the Master Zone receives the Secondary Zone controller voltage from the controller 100. Diodes Fig-DD-030 & Fig-DD-040 may be used to power the ISOLATION RELAYS.

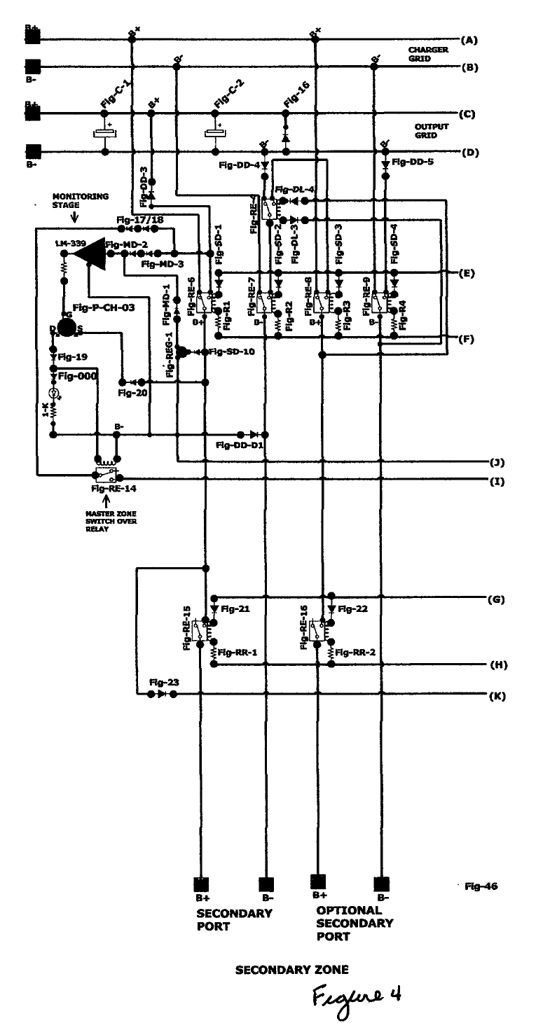

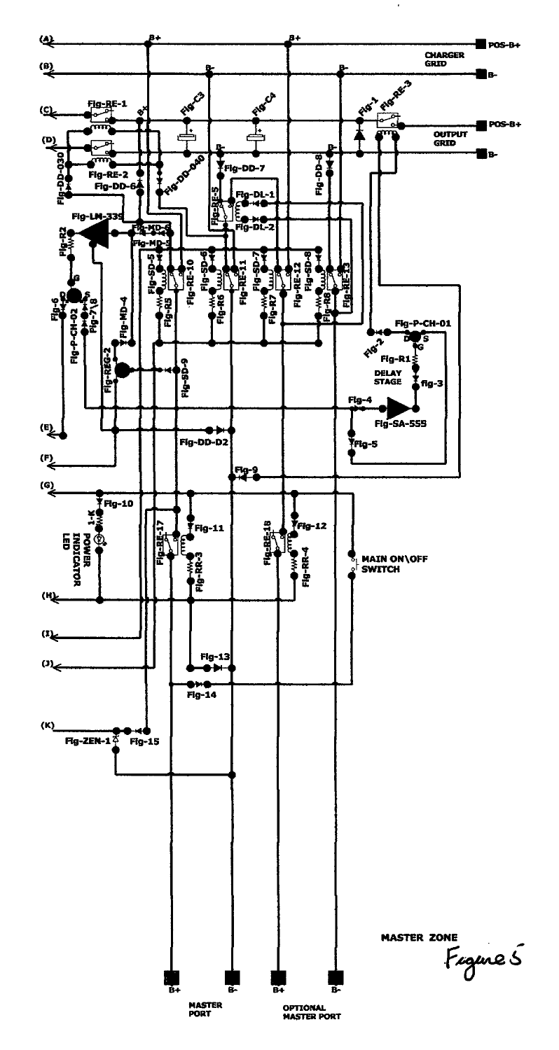

Pages# four and five/FIG. 4 and FIG. 5 show a separation of the Zones with Page# four/FIG. 4 illustrates the Secondary Zone Fig-46 while Page#5 FIG. 5 shows the Master Zone Fig-45. Each Zone is in its Complete Format. Letters (A) through (K) indicate where the connection for both Zones would be located. Element Fig-23 shown on Pg#4 FIG. 4 and element Fig-Zen-1 coupled with element Fig-15 shown on Pg#5/FIG. 5 are additional Protection and Stabilization components. Master Zone Switchover Relay Fig-RE-14 controls the enable & disable configuration of elements Fig-RE-10, RE-11, RE-12, & RE-13.

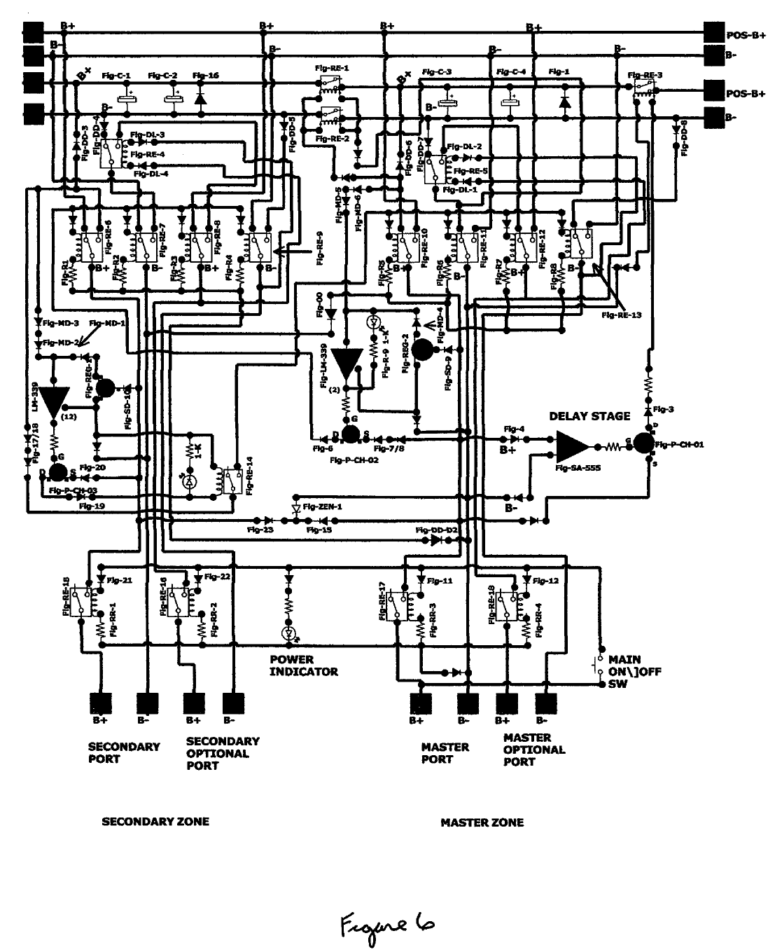

In contrast to Page#4/FIG. 4 & #5/FIG. 5 Page #6/FIG. 6 provides a substantially complete diagram of both Master and secondary Zone, when the controller 100 operates at for example twenty four (24) volts setting, Each zone Port may have a battery connected. Enabling the Main ON\OFF switch would cause the controller 100 to preformed several operations. First the controller 100 disables the Isolation Relays Fig-RE-1 & RE-2 causing a separation between the zones. This separation ensures that only the Master Zone may supply voltage to the grid. Second, the Output Voltage delay stage, Fig-SA555P and supporting components start a countdown (predetermined) period. At a set point the delay circuit Fig-SA555P activates the output relay Fig-RE-3 which in turn sends voltage to the grid.

The third task the controller 100 may perform is that the Optional Port controller Relays Fig-RE-4 & Fig-RE-5 are activated causing the output voltage to be doubled. If this voltage doubling is not required, the Optional Port batteries in both zones should be disconnected, the system would then operate as a twelve-(12) volt operation. Finally, the Secondary Zone batteries, would start receiving a replenishing voltage to maintain that secondary Zone batteries while the Master Zone provides the output voltage to the grid.

As the Master Zone Batteries continues to be depleted, the voltage monitoring chip FIG. 1M-339-01 and supporting component Fig-MD-5 & Fig-MD-6 Diodes senses the voltage on the grid. The voltage monitoring chip Fig-LM-339-01 then activate a transistor switch Fig-P-CH-02, this transistor switch Fig-P-CH-02 provides voltage to the Secondary Zone Switch Over Relays Fig-RE-6, RE-7, RE-8, & RE-9 to enable these components. This action causes the Secondary Zone to supply voltage to the grid but is blocked by the Isolation Relays Fig-RE-1 & Fig-RE-2 until the Master Zone is disabled by the controller 100.

Activating the Secondary Zone Switch over Relays, Fig-RE-6, RE-7, RE-8, & RE-9 would cause Fig-MD-3 & MD-2 to receive an increase in voltage. This increase Voltage would cause the voltage monitoring chip LM-339-02 to change its configuration and activate the relay Fig-RE-14. When the relay Fig-RE-14 is activated it supplies voltage to the Master Zone Switch over Relays Fig-RE-10, RE,-11, RE-12, & RE-13. This activation may eventually disable the Master Zone Fig-45. When the Master Zone Fig-45 is deactivated, the configuration in that Zone changes from supplying Voltage to the output grid to receiving charging voltage. Also the Isolation Relays Fig-RE-1 & RE-2 are activated, and voltage from the Secondary Zone fig-46 is applied to the output.

As the Secondary Zone fig-46 continue to supply voltage, it also would eventually deplete its voltage, causing the operating voltage of the voltage monitoring chip LM-339-02 to decrease. This reduction in operation voltage, would cause the Secondary Zone fig-46 to change its configuration, which would allow the controller 100 to reset its settings. Then the controller 100 may be reset by the Secondary Zone fig-46, the controller 100 may disable itself from the supply voltage to the grid and starts replenish the battery in that Zone. The Master Zone fig-45 may be also reset, changing the configuration of the master zone fig-45 from charging to supplying voltage to the grid. It should be noted that these switching operations are be conducted at extremely high speed.

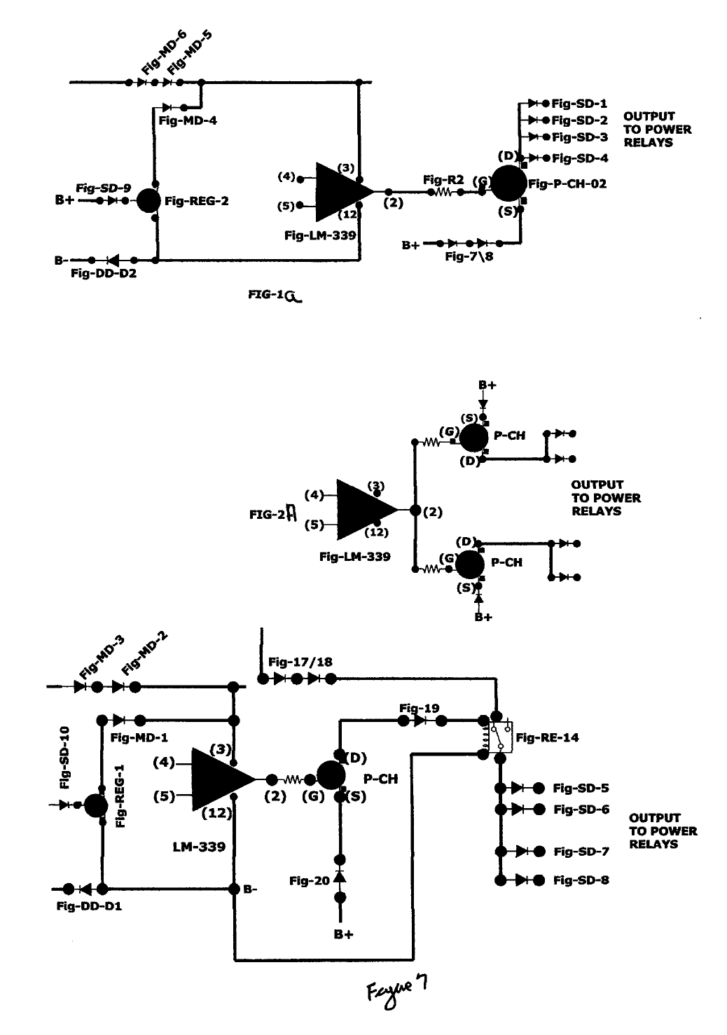

Page#7/FIG. 7 illustrates three important circuits to the operation of the controller 100. Fig-la indicates the components used to Monitor the batteries shown as diodes (Fig-MD-5, MD-6, & MD-4), and Supply low voltage Regulator (Fig-REG-2); these Regulators (Fig-REG-1 & Fig-REG-2) are used to hold the voltage monitoring circuit, in a stand-by mode when appropriate; FIG. 1a additionally illustrates the voltage Monitoring chip Fig-LM-339-01, and a transistor Fig-P-CH-02. This transistor Fig-P-CH-02 is used to Disable and Enable the Switchover relays in the Secondary Zone. The Diodes Fig-SD-1, SD-2, SD-3, & SD-4 on the output of the transistor Fig-P-CH-02 are used to regulate the voltage on the relays. Pg#7 Fig-1a shows only one.

The Transistor configuration on the output, however Fig-2a shows a more reliable design with two transistors. This two transistor configuration reduce the stress on a one transistor configuration, causing the design to be more efficient (reduce heat).

Finally, page#7 Fig-3a indicates the Secondary Zone Voltage Monitoring components, the transistor switch P-CH, and the Master Zone controlling Relay FIG-RE-14. This Relay FIG-RE-14 is control by the Secondary Zone fig-46 and is use to Enable & Disable the Master Zone Switch over relays Fig-RE-10, RE-11, RE-12, & RE-13. It should be noted that these components could be replaced with higher rating devices or could be completely replaced with different components. Example, the diodes that are used for Regulation purposes could be replaced with Regulator Transistors, and the Resistors that are used for voltage and amperage regulation could be replace with diodes or Regulation transistor. Finally, Relays could be replaced by adding any switch like devices (example) a Transistor with adjustment to the design.

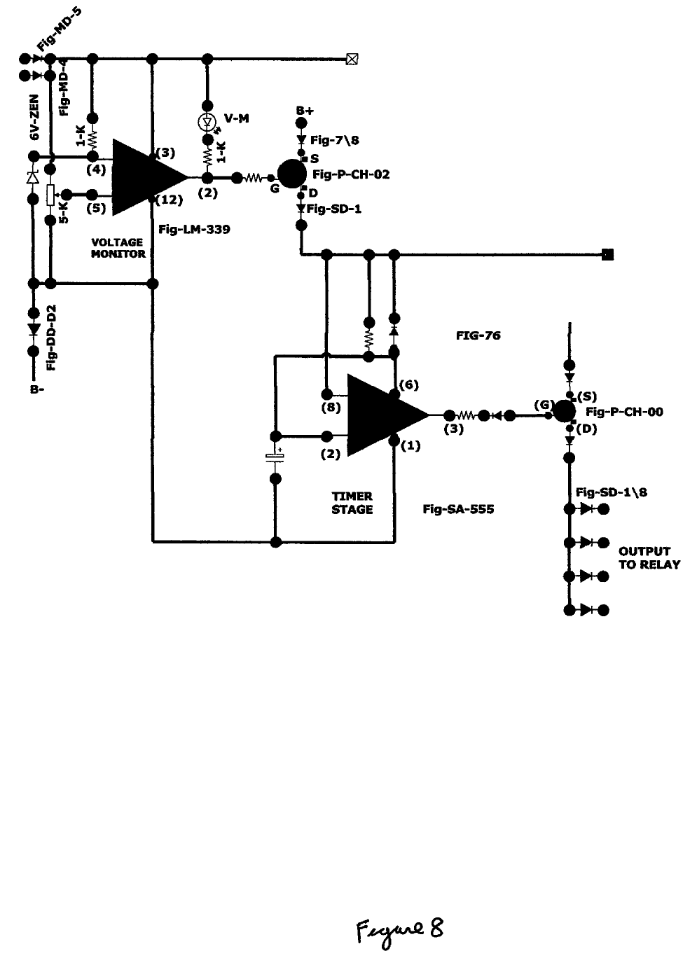

Page#8/FIG. 8 is an improvement over Page#7/FIG. 7. The circuit shows the components for sensing a low voltage.

However, there may be a Timing circuit Fig-76 connected to the output Transistor Fig-P-ch-02 and a supply diode Fig-SD-1. This timing stage stops the Switch Over procedure to ensure that the switch command from the controller 100 is correct. At the end of a countdown cycle and only if the timing stage continues to receive the activation command from the Voltage Monitoring stage, does it enable the Switchover Relays, when the Controller 100 supplies high amperage on the power grid to power high amp devices. It can cause a bounce or temporary low voltage in the power pack of the controller 100. This timing stage eliminates this problem of faults activation and is connected in both Zones for complete protection. The output of the timer Fig-76 drives a Transistor Fig-P-CH-00, which powers the supply diodes Fig-SD-1\8.

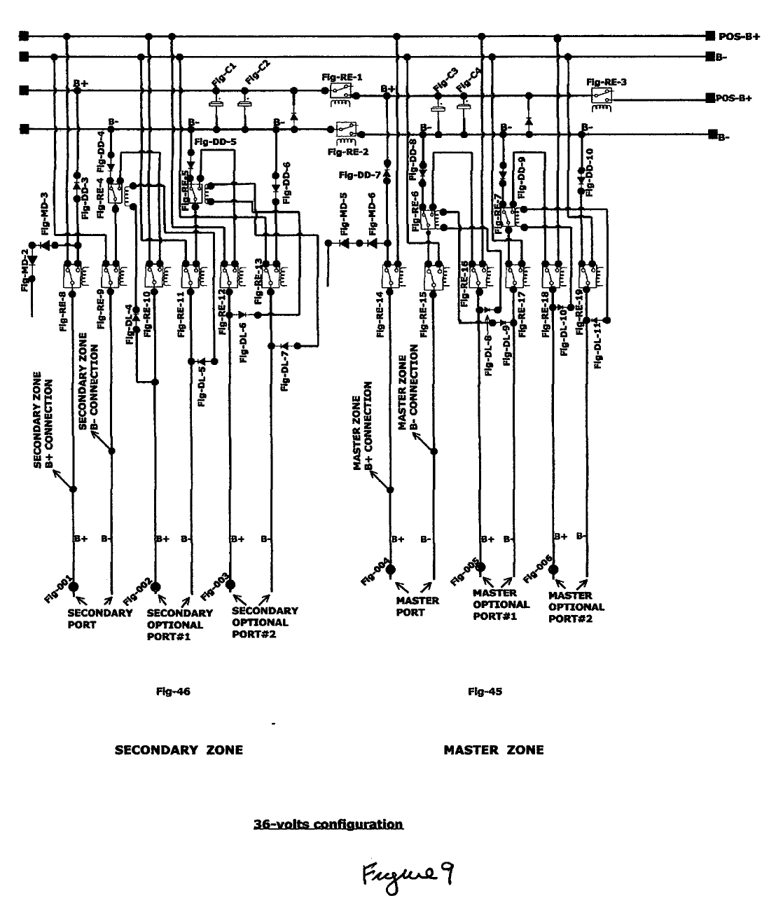

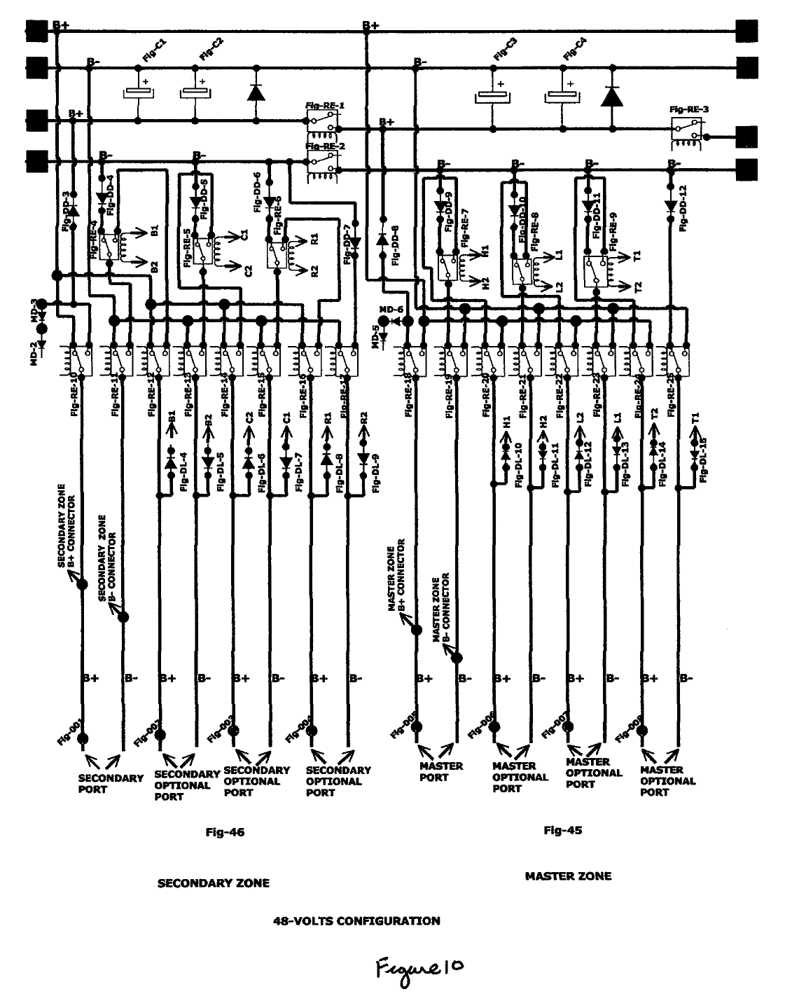

Additional drawings are illustrated on Page-9/FIGS. 9 & 10/FIG. 10. Page-9/FIG. 9 shows a 36-Volts three batteries per Zone configuration, totaling six batteries per unit. However, Page#10/FIG. 10 shows a 48-Volts four batteries per Zone configuration, and totaling eight batteries per controller 100. Each controller 100 can operate at different voltage level. Example, the 36-volts unit can operate from twelve volts minimum to thirty six volts maximum while the 48-volts version supplies twelve volts minimum to forty eight maximum output. This voltage flexibility is made available through the Optional Ports. The dots on each pages indicate the Positive B+ connection rails. Also indicated on these pages are the B+& B− connection for the Master Zone fig-45 and also the B+& B− connection Secondary Zone fig-46.

The Optional Port Switchover relays Fig-RE-4, RE-5, RE6, & RE-7 on page-9 FIG. 9 are connected to the supply Power rails. However, Page-10 FIG. 10 illustrates that these Relays Fig-RE-4, RE-5, RE6, & RE-7 are indicated with letters as to their connection points. The remainder of the circuit connections are substantially the same as Page-6/FIG. 6.

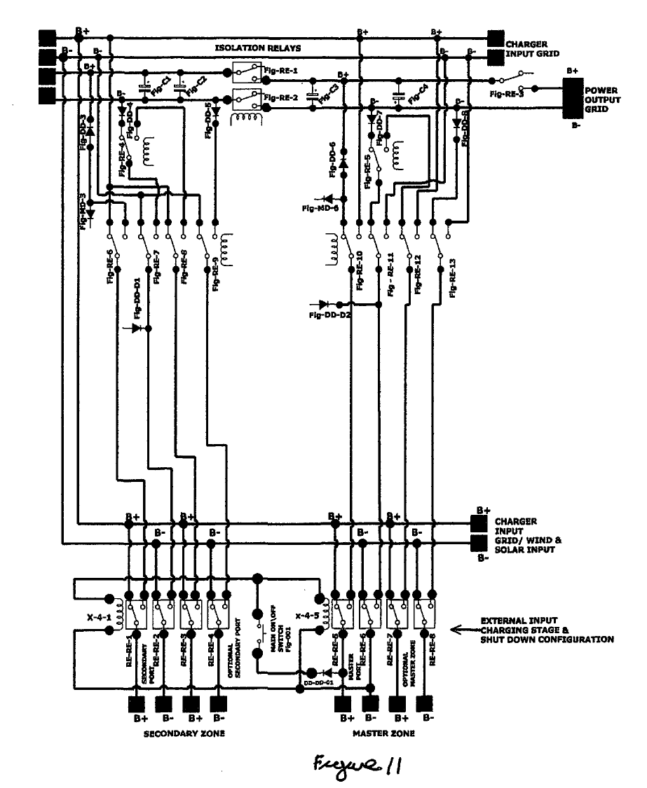

Finally, page-11/FIG. 11 configuration offers the operator of the controller 100, the ability to charge batteries when the unit Is activated but also when the unit is completely disabled. During normal operation, this zone is active, and the controller 100 determines which zone is being charged from the wind \ solar or any other 12 v power source—however, when the unit is disabled for a extended time, the controller 100 does not have control over this stage but the External charger source does. It achieves its objectives through Relays RE-RE-1-RE-RE-8.

It should be noted that the unit could incorporate addition Zones, which would enable the unit to add additional batteries for extended storage and operation. Also the unit could include a memory circuit. This memory circuit would give the controller 100 the ability to remember which zone it had last used—and return to that zone, eliminating the controller premature switchover.

1) A controller for controlling power flows, comprising:
a first charging circuit to charge and discharge a first battery responsive to the controller;
a second charging circuit to charge and discharge a second battery responsive to the controller;
wherein the first charging circuit and the second charging circuit alternates between charging and discharging; wherein the first charging circuit charges while the second charging circuit discharges and the first charging circuit discharges while the second charging circuit charges.

2) A controller for controlling power flows as in claim 1, wherein the controller includes monitoring supply diodes.

3) A controller for controlling power flows as in claim 1, wherein the controller includes regulators transistors to provide a low voltage in conjunction with the monitoring diodes.

4) A controller for controlling power flows as in claim 1, wherein the controller includes at least one isolation relay.

5) A controller for controlling power flows as in claim 1, wherein the controller includes blocking diodes.

6) A controller for controlling power flows as in claim 1, wherein the controller includes switch over relays.

7) A controller for controlling power flow as in claim 1, wherein the controller includes voltage monitoring chips.

8) A controller for controlling power flow as in claim 1, wherein the controller includes Power-Transistors.
